(19) United States
(12) Patent Application Publication
(10) Pub. No.: US 2010/0125991 A1
(43) Pub. Date: May 27, 2010

(54) Pneumo-Hydraulic Rivet Gun

(75) Inventor: Giuseppe Preti, Bologna (IT)

Correspondence Address: WILLIAM J. SAPONE;COLEMAN SUDOL SAPONE P.C., 714 COLORADO AVENUE, BRIDGE PORT, CT, 06605, US

(73) Assignee: OBER S.P.A., Cadriano Di Granarolo (IT)

(21) Appl. No.: 12/596,953

(22) PCT Filed: Apr. 23, 2008
(86) PCT No.: PCT/IB08/00995

§ 371 Date: Oct. 21, 2009

(30) Foreign Application Priority Data
Apr. 27, 2007 (IT) BO2007-000311

(51) Int. Cl. B23P 11/00

(52) U.S. Cl. 29/243.525

(57) ABSTRACT

A pneumo-hydraulic rivet gun, comprising: a pneumatic motor (1), which sets a threaded tie-rod (2) in rightwards or leftwards rotation to engage the tie-rod (2) or disengage the tie-rod (2) from the threaded hole (3A) of a rivet (3); an oleodynamic system (4) for determining a plastic deformation of a portion of the rivet (3), such as to secure the rivet (3) to a wall (P); a pneumatic booster (5) which activates a plunger (50) that compresses the fluid (F) of the oleodynamic system (4); a pneumatic system (6) provided with an auxiliary valve (60), which is opened by the tie-rod (2) and allows the supply of the rightwards rotating motor (1), and with a main valve (61), which is opened by a trigger (62) subsequent to the reclosing of the auxiliary valve (60) in order to allow the connection of an air supply conduit (65) to a source of compressed air: a hydro-pneumatic exchange valve (10), connected to the air supply conduit (65), oleodynamic system (4), pneumatic booster (5), the exchange valve (10) allowing, in the following order and subsequent to intervention by the operator on the trigger (62), activation of the pneumatic booster (5), the pressurization of the oleodynamic system (4) with consequent plastic deformation of the rivet, the activation of the pneumatic motor (1) with leftward rotation of the tie-rod (3) which uncouples from the rivet (3) and, following the release of the trigger, a halt of the pneumatic motor.

### TECHNICAL FIELD

This invention concerns the technical sector of rivet guns, with particular reference to power-activated rivet guns which are used for cylindrically-shaped rivets having a partially threaded axial hole, a strike collar in proximity of a head, and a suitably weakened portion where the plastic deformation is localized.

The rivets are destined to join two walls stably, for example instead of using spot welding, or to constitute an adequately sturdy threaded anchoring bush for structures made with materials which are too soft or too thin to afford sufficiently resistant threading.

The rivets can be of considerable dimensions, and the equipment necessary to put them in place must be capable of exerting a high compression force upon them.

### BACKGROUND ART

A rivet gun known from European Patent EP 0.999.906, which belongs to this Applicant, comprises a body and a grip which house the following:

a pneumatic motor, which makes a threaded tie-rod rotate rightwards or leftwards, respectively to engage the threaded tie-rod with, or disengage the threaded tie-rod from, the threaded axial hole of a corresponding rivet;

an oleodynamic system, which imposes axial translation on the motor-tie-rod group, so as to determine the plastic deformation of the predetermined portion of the rivet, with a force which is pre-set by a maximum pressure valve;

a pneumatic thrust booster driving a plunger which compresses the fluid of the oleodynamic system;

a pneumatic system, in which the following are provided: an auxiliary valve which is opened by the tie-rod; a main valve, which is activated to open by a relative trigger; a discharge valve, which is opened at the end of a predetermined travel of the motor-tie-rod group; a flow regulation valve, which is opened at the end of the rivet fastening stage; a timing device, which activates the motor to rotate leftwards and can automatically stop the motor after a predetermined time.

The gun functions as follows:

the rivet is arranged in the hole which has been prepared for this purpose in the structure, with the relative strike collar strikingly against the structure, or alternatively, the rivet is manually positioned in front of the tie-rod of the gun;

the tie-rod is inserted into the axial hole of the rivet, up to the beginning of the threading of the rivet, in this way determining an axial thrust on the tie-rod towards the body of the gun, thus causing the auxiliary valve to open and allowing compressed air to be sent to the motor, thereby making the motor rotate rightwards and screwing the tie-rod into the rivet; when the strike collar of the rivet is strikingly against the forward head of the body, the auxiliary valve automatically closes and thus the motor stops;

depressing the trigger and releasing it immediately initiates the automatic operating cycle of the gun; pressure on the trigger opens the main valve, which allows the compressed air to be sent to the thrust booster, consequently increasing the pressure of the oleodynamic fluid and initiating the axial translation of the motor-tie-rod group;

the translation continues, causing progressive compression of the rivet, the weakened portion of which therefore deforms towards the outside, thereby defining an annular edge, which adheres to the surface of the structure which is opposite that on which the collar rests, thus securing the rivet in place;

depending on whether the maximum travel operating modality or the maximum pressure operating modality respectively has been selected, the discharge valve or the maximum pressure valve intervene, closing the main valve and stopping the flow of air towards the thrust booster;

part of the compressed air stored in the thrust booster is discharged externally through the flow regulation valve, while the remaining compressed air is sent to the timing device, which makes the motor rotate leftwards, thus unscrewing the tie-rod from the rivet; when the compressed air contained in the thrust booster is exhausted, the motor stops automatically;

by acting on the flow regulation valve the time of functioning of the motor can be adjusted in relation to the length of the rivet.

The rivet gun above described functions extremely well, but its automatic operating cycle has shown a limitation regarding fulfilling the requirements of intensive or excessive use, where it is important to reduce downtimes between applying one rivet and the next to a minimum.

The motor, being activated to rotate leftwards to disengage the threaded tie-rod from the rivet just applied, continues to function automatically for the time which is predetermined by the timing device, therefore this time needs to be sufficiently long to allow the threaded tie-rod to be completely unscrewed.

Under normal conditions, therefore, when the tie-rod disengages from the rivet which has just been applied, the motor continues to function residually for a short time, thus preventing a new rivet from being engaged immediately, since this would damage the thread of the new rivet.

If, for any reason, faulty conditions of resistance arise while unscrewing the tie-rod, air “consumption” by the motor increases, with the motor probably stopping precociously, leaving the tie-rod still partially engaged; in this case it is necessary to activate an emergency command with which the gun is provided, and which further supplies the motor to extend its functioning.

It is easy to understand how, given a complex structure with a large number of pre-positioned rivets, even a few seconds of unnecessary pause, when passing from one rivet to the next, determine an overall onerous increase in operating times, which is further compounded by the operator's “loss of working rhythm”.

The presence of the timing device, posteriorly associated to the pneumatic motor, entails a considerable increase in the weight and bulk of the rivet gun, which over prolonged use augments the exertions required of the operator and limits the gun's maneuverability in close spaces.

The choice which the above-described known rivet gun offers between the maximum pressure and the maximum travel operating modalities has proved to be of little practical use, the maximum travel option often being ignored, since compared with the maximum pressure option the maximum travel parameter is less important for obtaining an optimal fastening of the rivet to the structure.

To increase ease of handling for an operator, the need has arisen to eliminate the timing device and modify the automatic functioning of the gun, leaving the operator to decide when to interrupt the leftwards rotation of the motor for unscrewing, thereby adapting the rotation to the requirements of the moment and synchronizing the rotation with disengagement of the tie-rod from the rivet.

Thus the aim of the invention is to provide a gun for applying rivets, designed in such a way that after having engaged the tie-rod in the rivet, the operator has to depress the trigger to start the automatic operating cycle, and keep the trigger depressed until the tie-rod disengages from the applied rivet, with the motor rotating leftwards, the stopping of the motor being subordinated to the release of the trigger.

Another aim of the invention consists in providing a gun which is much more compact and lighter than those in the prior art.

A further aim of the invention concerns simplifying production of the gun, by eliminating components such as the timing device and the discharge valve, which are dependent on the maximum travel option.

### DISCLOSURE OF INVENTION

A pneumo-hydraulic rivet gun, comprising: a pneumatic motor, which sets a threaded tie-rod in rightwards or leftwards rotation to engage the tie-rod or disengage the tie-rod from the threaded hole of a rivet; an oleodynamic system for determining a plastic deformation of a portion of the rivet, such as to secure the rivet to a wall; a pneumatic booster which activates a plunger that compresses the fluid of the oleodynamic system; a pneumatic system provided with an auxiliary valve, which is opened by the tie-rod and allows the supply of the rightwards rotating motor, and with a main valve, which is opened by a trigger subsequent to the reclosing of the auxiliary valve in order to allow the connection of an air supply conduit to a source of compressed air: a hydro-pneumatic exchange valve, connected to the air supply conduit, oleodynamic system, pneumatic booster, the exchange valve allowing, in the following order and subsequent to intervention by the operator on the trigger, activation of the pneumatic booster, the pressurization of the oleodynamic system with consequent plastic deformation of the rivet, the activation of the pneumatic motor with leftward rotation of the tie-rod which uncouples from the rivet and, following the release of the trigger, a halt of the pneumatic motor.

### BRIEF DESCRIPTION OF THE DRAWINGS

The characteristics of the invention will emerge from the following description of a preferred embodiment thereof, in accordance with the claims and with the aid of the appended figures of the drawings, in which:

FIGS. 1 to 8 show schematic views of the rivet gun of the invention, during the most salient operating stages;

FIG. 9A shows, on an enlarged scale, an axial section of a component of the gun, in a first embodiment thereof;

FIG. 9B shows the same component of FIG. 9A, in a second embodiment thereof.

### BEST MODE FOR CARRYING OUT THE INVENTION

In the figures, the gun for applying rivets of the invention is indicated with 100.

The gun 100 comprises a body 101 and a grip 102 within which the following are housed in a known way:

a pneumatic motor 1, which rotates a threaded tie-rod 2 leftwards or rightwards, respectively for engaging the threaded tie-rod 2 with, or disengaging the threaded tie-rod 2 from, the threaded axial hole 3A of a corresponding rivet 3;

an oleodynamic system 4, which imposes an axial translation on the motor-tie-rod group, thus causing plastic deformation of a predetermined portion of the rivet 3, in such a way as to secure the rivet 3 to a corresponding wall P;

a pneumatic thrust booster 5 activating a plunger 50 which compresses the fluid F of the oleodynamic system 4;

a pneumatic system 6, which is provided with an auxiliary valve 60, which is opened by the tie-rod 2, allowing supply to the rightwards-rotating motor 1, and a main valve 61, which is opened by a relative trigger 62, subsequent to re-closing of the auxiliary valve 60, allowing the supply to the pneumatic thrust booster 5 and the leftwards-rotating motor 1.

The gun further comprises an emergency command 63 of a substantially known type, which is associated to the pneumatic system 6 and sets the motor 1 in leftwards rotation, in conditions which will be illustrated below.

The gun 100 according to the invention is provided with a hydropneumatic exchange valve 10, which is connected to the oleodynamic system 4 and the pneumatic system 6, and which comprises:

first mobile organs 11, constituted by an assembly 110, which slides axially inside a jacket 20 of the exchange valve 10 with which it is solid at one end thereof, a stem 111, which slides in an axial hole afforded in a head 20A of the jacket 20 from which it exits, extending inside a blind conduit 41, which blind conduit 41 is connected to the oleodynamic system 4 and occupied by the fluid F thereof; the assembly 110 is subjected to the action of first elastic organs 112, which are provided on the side opposite the stem 111 and maintain the stem 112 strikingly against the head 20A when the pressure in the lower conduit is below a predetermined value;

an opening 21 in the jacket 20 for injecting compressed air coming from the main valve 61 into the jacket 20, through an air supply conduit 65 provided in the pneumatic system 6;

second mobile organs 12, which switch the compressed air supply coming from the main valve 61 from the pneumatic thrust booster 5 to the pneumatic motor 1, constituted for example by a sleeve 120, slidingly and sealingly constrained on the assembly 110, inside the jacket 20, and subjected to the action of respective second elastic organs 121, which generate a force directed towards the head; the sliding of the sleeve 120 is limited by its striking against a stop 113 afforded by the assembly 110, thus defining an initial position R for the sleeve 120.

The sleeve 120 gives rise at its ends to a forward collar 122 and a collar 123 in which ring seals 124, 125 are inserted, which slidingly meet the internal wall of the jacket 20;

an annular passage 22, defined between the jacket 20 and the portion of sleeve 120 included between the respective collars 122, 123, which communicates with the opening 21 and with a chamber 23, in a phase relation with the initial position R of the sleeve 120; the chamber 23 is connected to a first delivery conduit 66 directed towards the thrust booster 5;

an annular chamber 24, defined between the jacket 20, the head 20A of the jacket 20, and the forward collar 122 of the sleeve 120, which communicates with the opening 21 and with a transfer port 25, in a phase relation with the moving of the sleeve 120 to an operating position K which is determined by the translation of the assembly 110 as a consequence of the oleodynamic fluid F reaching a predetermined maximum pressure; the transfer port 25 is connected to a second delivery conduit 67 directed towards the pneumatic motor 1, to make the motor 1 rotate leftwards.

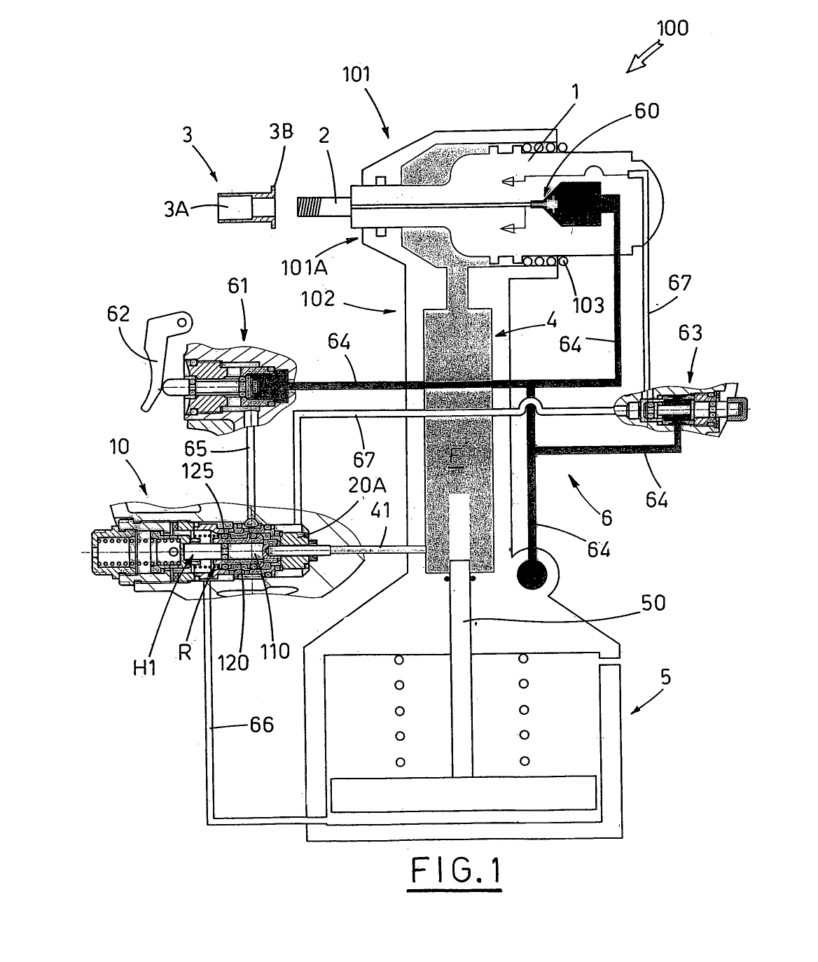

In a first embodiment (shown in FIGS. 1 to 9A), the hydropneumatic exchange valve 10 is provided with a cartridge 30, containing the first elastic organs 112, acting on the assembly 110 with a predetermined elastic reaction, which is calibrated on the basis of the maximum pressure of the oleodynamic fluid F to be reached.

The cartridge 30 is interchangeable with others, the elastic organs 112 of which have different settings, in order to modify the maximum pressure reachable by the fluid F.

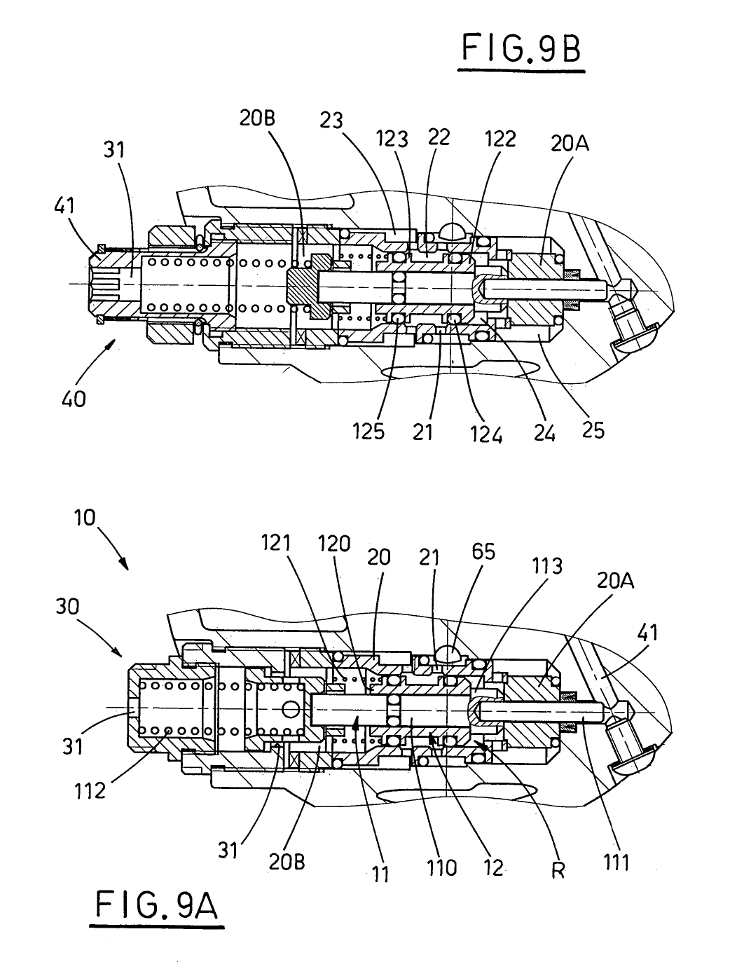

In a second embodiment, shown in FIG. 9B, the cartridge 40 comprises a pawl 41, which is adjustable from the outside, and is able to modify the preload of the first elastic organs 112, in order to vary the elastic reaction of the first elastic organs 112 within a range between minimum to maximum, corresponding to predetermined maximum pressure values of the fluid F.

Holes 31 afforded in the cartridge 30, 40 place the rear part 20B of the jacket 20 in communication with the outside, the inner diameter thereof being greater than the remaining part, the function of which will be described below.

There follows a description of how the gun 100 functions when applying a rivet 3 to a wall P.

In FIG. 1, the gun 100 is not operating, with:

the pneumatic motor 1 inactive;

the pressure of the oleodynamic system 4 at the minimum, with the motor-tie-rod group which is advanced towards the forward head 101A of the body 101, through the action of a relative contrast spring 103;

the pneumatic system 6, supplied with compressed air coming from an external source (not shown), creates pressure only in the infeed conduit 64, which branches towards the auxiliary valve 60, the main valve 61 and the emergency command 63, all of which are in the respective closed or rest positions;

the exchange valve 10 at ambient pressure, with the assembly 110 strikingly against the head 20A of the jacket 20 (advanced position HI) and the sleeve 120 in the relative initial position R, in which the ring seal 125 of the rear collar 123 is situated anteriorly to the rear part 20B, closing the passage between the rear part 20B and the remaining part of the jacket 20.

The rivet 3 is arranged in the hole provided in the wall P for this purpose, with the relative collar 3B which is strikingly against the wall P, or alternatively, the rivet 3 is positioned manually in front of the tie-rod 2 of the gun 100 (see FIG. 1).

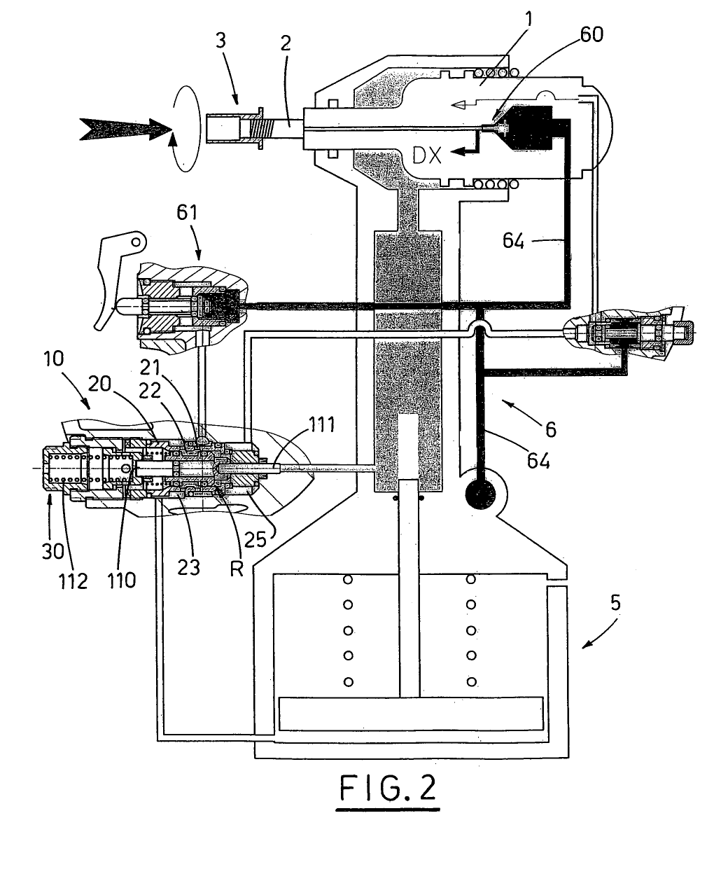

As with the known rivet gun mentioned in the preamble, the tie-rod 2 is inserted in the axial hole 3A of the rivet 3, as far as the start of the thread thereof, thus determining an axial thrust on the tie-rod 2, with translation of the tie-rod 2 towards the body 101 of the gun 100; this causes the auxiliary valve 60 to open, thus allowing compressed air to be sent to the motor 1, setting the motor 1 in rightwards rotation in order to screw the tie-rod into the rivet 3 (FIG. 2).

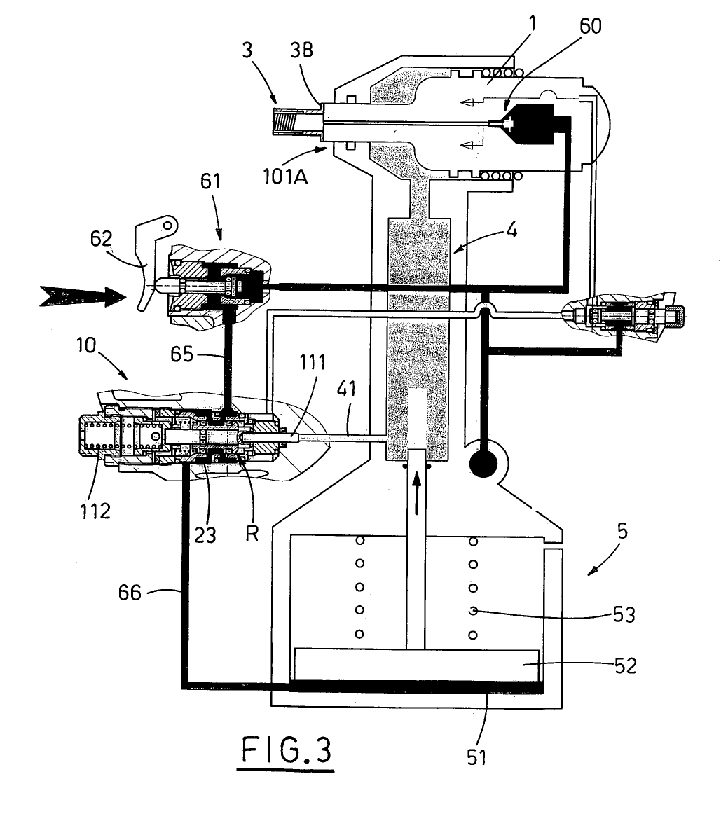

When the collar 3B of the rivet 3 is strikingly against the forward head 101A of the body 100, the auxiliary valve 60 is automatically closed and therefore the motor 1 stops (FIG. 3).

Depressing the trigger 62 makes the main valve 61 open and initiates the automatic operating cycle of the gun 100.

When the main valve 61 opens, compressed air flows into the air supply conduit 65, entering the hydropneumatic exchange valve 10 through the opening 21 of the jacket 20.

With the sleeve 120 in the initial position R, the compressed air coming from the opening 21 is diverted towards the annular passage 22, and from here to the chamber 23, thereafter being channelled into the first delivery conduit 66 and reaching the cylinder 51 of the thrust booster 5 (see FIG. 3).

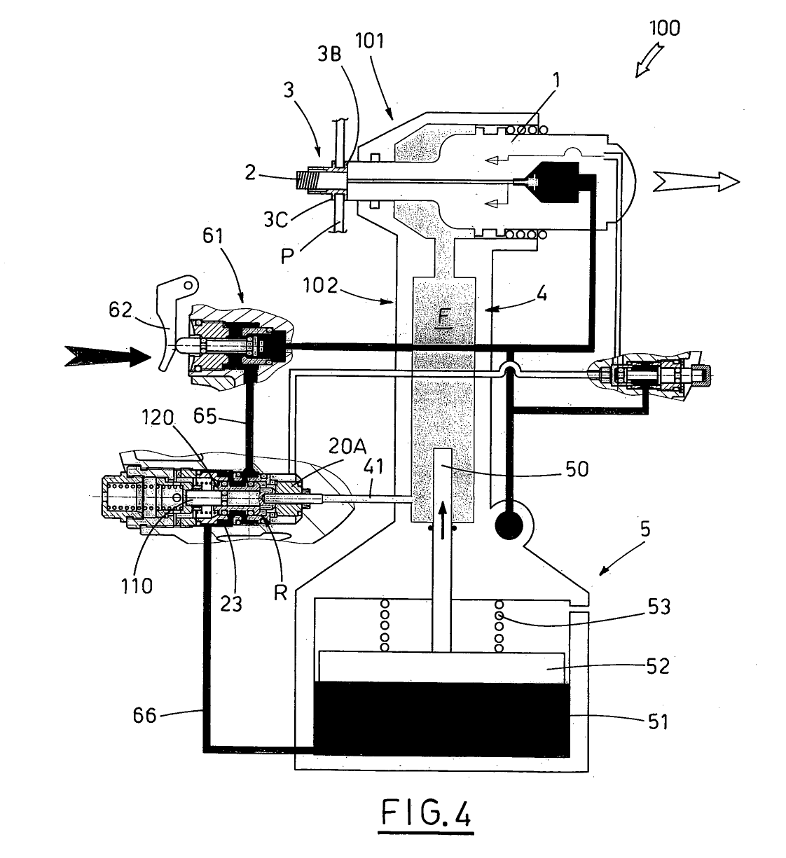

Keeping the trigger 62 depressed results in air continuing to be sent to the thrust booster 5; the increase in the air pressure inside the cylinder 51 makes the piston 52 rise, contrasting a relative spring 53, and the contemporaneous rise of the plunger 50 acting on the fluid F, consequently raising the pressure of the fluid F, and starting the axial translation of the motor-tie-rod group (FIG. 4).

Translation continues, causing progressive compression of the rivet 3, the weakened portion of which therefore deforms towards the outside, thus defining an annular edge 3C, which adheres to the surface of the wall P opposite the surface on which the collar 3B rests, thereby securing the rivet 3 (see FIG. 4 again).

The increased pressure in the oleodynamic system 4 also affects the fluid F present in the blind conduit 41, determining an axial thrust on the stem 111, and on the assembly 110, which can overcome the resistance of the elastic organs 112; therefore the assembly 110 is translated backwards, drawing with it the sleeve 120, also overcoming, by means of the stop 113, the resistance of the relative elastic organs 121.

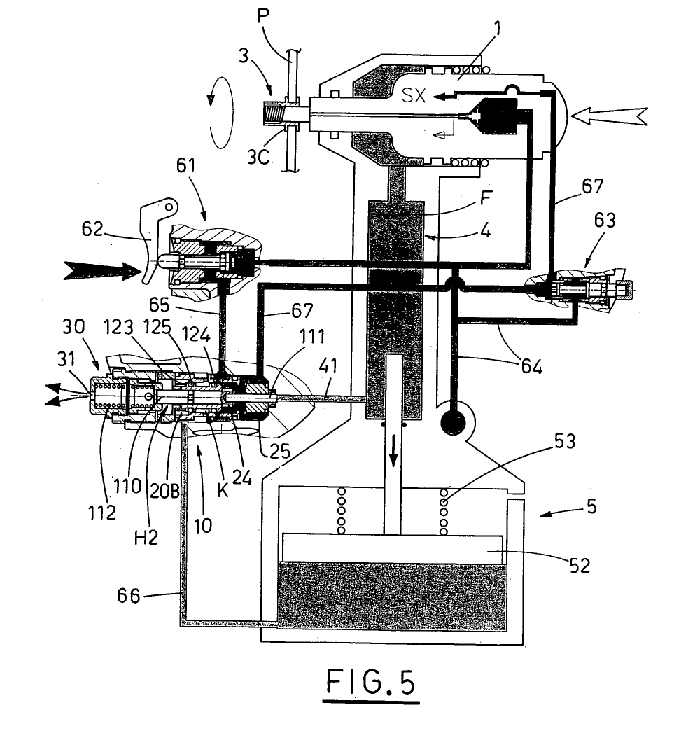

When the maximum pressure of the oleodynamic fluid F is reached, the assembly 110 is pushed to the extreme retracted position H2, bringing the sleeve 120 to the relative operating position K, in which the ring seal 124 of the relative forward collar 122 is situated on the opposite site of the opening 21 (FIG. 5).

Consequently the supply of air towards the annular passage 22 is closed, thus interrupting delivery to the thrust booster 5; contemporaneously the rear collar 123 is in proximity of the widened rear part 20B of the jacket 20, in which the relative seal ring 125 does not adhere to the jacket 20 and allows the air which is contained in the thrust booster 5 to travel back along the trajectory through the first delivery conduit 66, the chamber 23, the annular passage 22 and then to exit from the exchange valve 10 through the holes 31 in the cartridge 30.

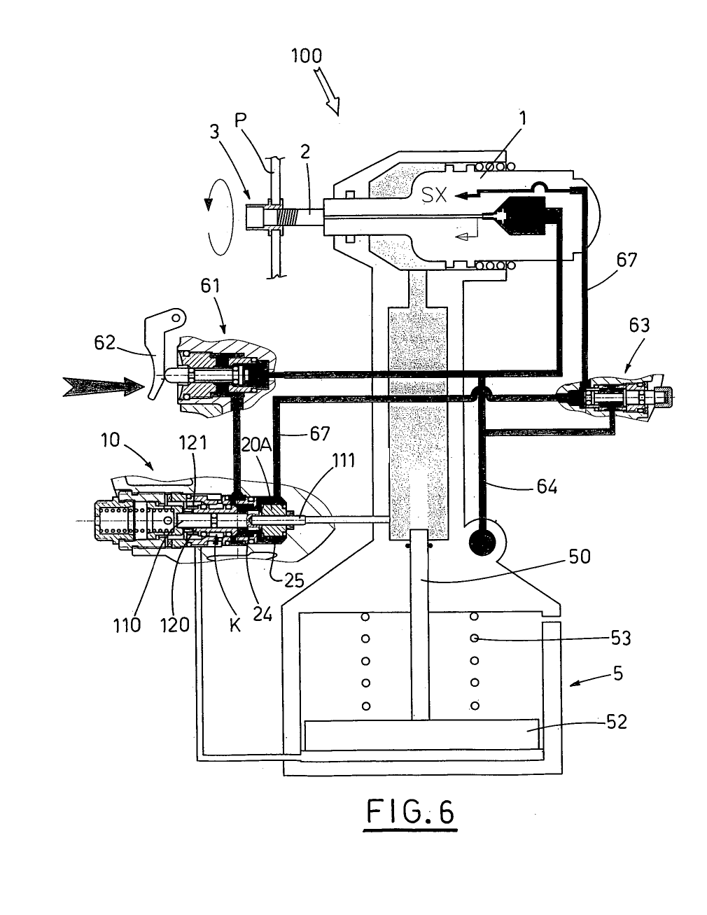

Discharge of the air from the thrust booster 5 is favoured by the elastic reaction of the spring 53, which by extending, brings the piston 52 and the plunger 50 back down (FIG. 6).

The aforementioned causes a sharp drop in the pressure of the oleodynamic fluid F, thereby terminating retraction of the motor-tie-rod group and thus also the pressure on the rivet 3 (FIG. 6).

The switch in the position of the sleeve 120, sets the opening 21 in communication with the annular chamber 24, so that the compressed air entering the annular chamber 24 is directed towards the transfer port 25, thereafter reaching the motor 1 through the second delivery conduit 67, thus making the motor 1 rotate leftwards to start unscrewing the tie-rod 2 from the rivet 3 now fastened to the wall P (FIG. 6).

The rapid drop in the pressure in the oleodynamic system 4 allows the first elastic organs 112 to bring the assembly 110 back to its advanced position, striking against the head 20A (FIG. 6).

The air pressure which is established inside the annular chamber 24, despite air being delivered to the motor 1, is sufficient to overcome the weak resistance of the second elastic organs 121, so that the sleeve 120 is maintained in the operating position K, despite the thrust for the shift from the initial position R, which was originally provided by the assembly 110, dying out (see FIG. 6 once more).

The above-described condition lasts for as long as the trigger 62 is kept depressed, thus the leftwards rotation of the motor 1, which is required for unscrewing the tie-rod 2 from the rivet 3 just applied, continues for as long as the operator wishes.

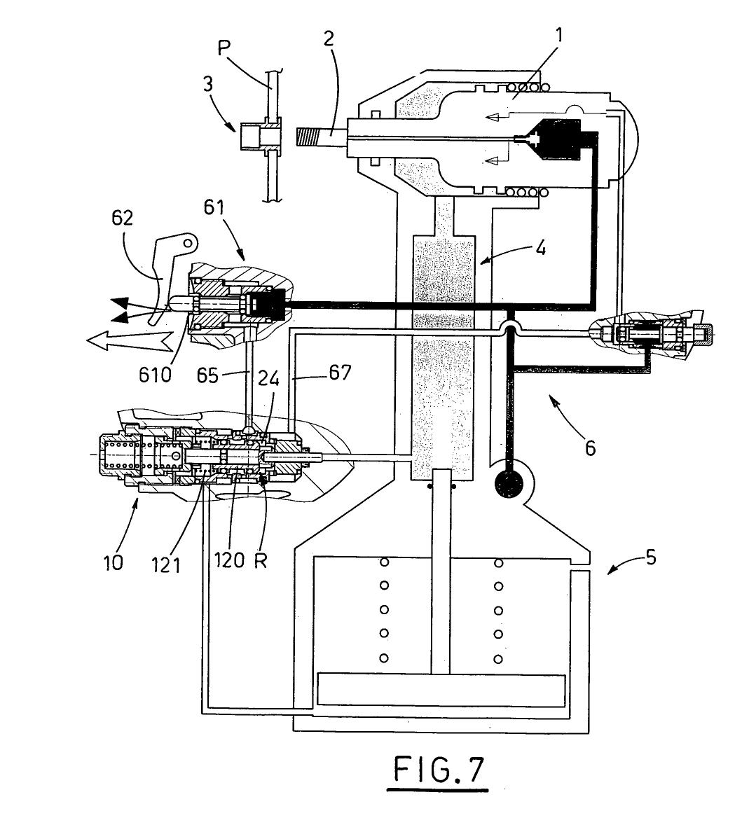

When the trigger 62 is released, with the closing of the main valve 61, the supply of air to the air supply conduit 65, and thus also to the exchange valve, 10 is interrupted; since there is no longer any pressure inside the annular chamber 24, the second elastic organs 121 can push the sleeve 120 back to the initial position R, thus closing the passage towards the second delivery conduit 67 (FIG. 7).

Thus leftwards rotation of the motor is stopped, while the residual compressed air which is contained in the exchange valve 10 flows back through the air supply conduit 65 and is discharged externally through suitable holes 610 provided in the main valve 61 (see FIG. 7).

At this point the gun 100 is once again in the condition described in FIG. 1.

Thus an operator can optimally synchronize the completion of disengagement of the tie-rod 2 by stopping the motor 1, thus immediately readying the gun 100 for another rivet 3 which was priorly positioned in the wall P.

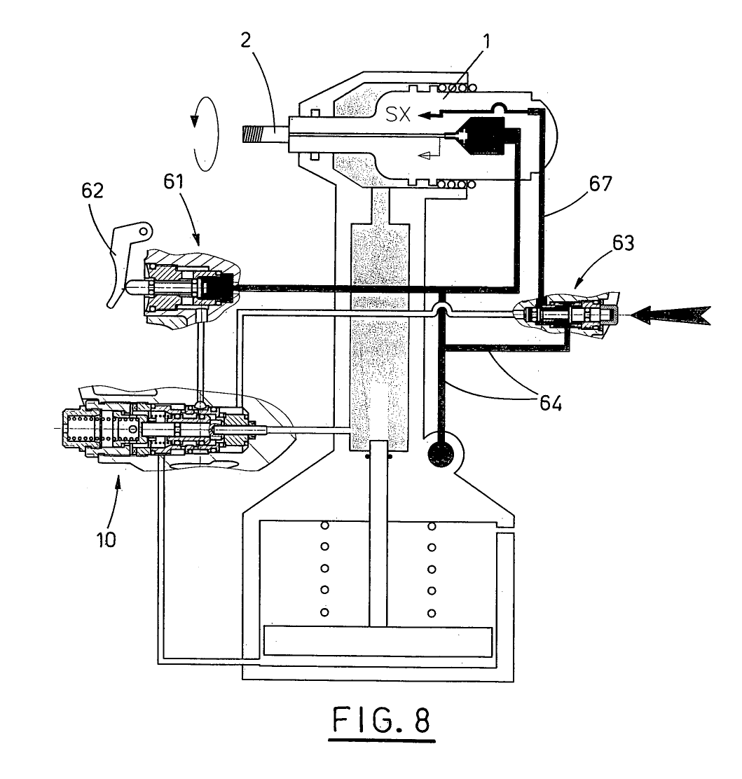

If the trigger 62 is released by mistake or for any other reason before disengagement of the tie-rod 2 is completed, the unscrewing operation can be completed by depressing the emergency command 63; in this way, the compressed air present in the infeed conduit 64 is injected into the second delivery conduit 67, to supply the motor 1 and make it rotate leftwards (FIG. 8).

Note that the gun 100 as described is not minimally affected by any operating error if, after anticipated release of the trigger 62, renewed pressure is exerted on the trigger 62, instead of activating the emergency control 63.

In this case, in fact, the gun repeats the automatic operating cycle on the tie-rod 2 without applying unwanted pressure on the secured rivet 3, since when the prior maximum pressure of the fluid F is reached again, the exchange valve 10 interrupts the action and starts unscrewing, so that the only resulting drawback is a slight loss of time.

The particular characteristics of the gun of the invention emerge extremely clearly from the foregoing, in particular the fact that it provides an automatic cycle which ensures a precise halt to the pressure on the rivet when the predetermined maximum pressure is reached, and prompt activation of the motor to disengage the tie-rod, while leaving the operator to decide when to interrupt the disengagement operation, thus avoiding difficult calibration operations on the timing device and reducing to a minimum the downtimes and drawbacks which accompany intensive use of the gun.

The elimination of the timing device, and of the components necessary for the maximum travel modality of operation, makes this gun, in comparison with guns in the prior art, as illustrated in the preamble, much more compact and lighter, which is definitely advantageous for ease of handling in restricted spaces and for reducing operator fatigue when it is used for extended periods of time.

The foregoing in any case is a non-limiting example, thus any modifications to details which should become necessary, for constructional and/or functional reasons, must be considered as falling within the ambit of protection defined by the following claims.

1. A pneumatic-hydraulic rivet gun of a type comprising: a pneumatic motor (1), which rotates a threaded tie-rod (2) in a rightwards or a leftwards direction, respectively to engage the tie-rod (2) with or disengage the tie-rod (2) from a threaded axial hole (3A) of a corresponding rivet (3); an oleodynamic system (4) which impresses an axial translation on the motor tie-rod group, thus determining plastic deformation of a predetermined portion of the rivet (3), in such a way as to fasten the rivet (3) to a corresponding wall (P); a pneumatic thrust booster (5), for activating a plunger (50) which compresses a fluid (F) of the oleodynamic system (4); a pneumatic system (6) supplied by a source of compressed air and providing an auxiliary valve (60), which auxiliary valve (60) is opened by the tie-rod (2), for allowing supply to the motor (1) when the motor (1) is rotating rightwards, and a main valve (61), which is opened by a relative trigger (62), subsequent to the re-closing of the auxiliary valve (60), which main valve (61) connects a relative air supply conduit (65) with the compressed air source, characterized in that it comprises a hydropneumatic exchange valve (10), connected to the air supply conduit (65), to an oleodynamic system (4), to a pneumatic thrust booster (5), to a pneumatic motor (1), which hydropneumatic exchange valve (10) comprises: first mobile organs (11), on one side subjected to the pressure of the oleodynamic fluid and on another side subjected to relative first elastic organs (112), which first mobile organs (11) define an advanced position (HI) corresponding to a minimum pressure value, and a retracted position (H2) corresponding to a predetermined maximum value of the pressure; second mobile organs (12), associated to the first mobile organs (11), defining, together with the first mobile organs (11) in the advanced position (H1) and through the action of the relative second elastic organs (121), a rest position (R) which allows connection of the air supply conduit (65) to the pneumatic thrust booster (5), the second organs (12) being drawn by the first organs (11) in the translation of the first organs (11) towards the retracted position (H2) thus defining, in contrast with the second elastic organs, an operating position (K) which causes interruption of the supply of compressed air to the pneumatic thrust booster, (5) in order to direct the compressed air into a second delivery conduit (67) of the pneumatic motor (1) in order to activate the pneumatic motor (1) in a leftward rotation, and places the pneumatic thrust booster (5) in a discharge mode with a consequent return of the first mobile organs (11) to the advanced position, through the action of the relative first elastic means; an annular chamber (24) which communicates with the second conduit (67), the second mobile organs being in the operating position (K), in order to set the second mobile organs in contrast with the relative second elastic organs (121) to maintain the operating position (K), the operator releasing the trigger of the main valve (61) leading to interruption of the connection of the air supply conduit (65) with the compressed air source, with return of the second mobile organs (12) to the rest position (R), through the action of the relative second elastic organs (121), and consequently stopping the motor (1).

2). The gun of claim 1, characterized in that the first mobile organs (11) are constituted by an assembly (110), which slides axially inside a jacket (20) of the exchange valve, at an end of which a stem (111) is solidly constrained, projects from a head (20A) of the jacket (20) and extends inside a blind conduit (41) which is connected to the oleodynamic system (4) and occupied by the fluid F of the oleodynamic system (4), the assembly (110) being subjected to action of the first elastic organs (112), which maintain the assembly (110) in a abutting position against the head (20A) when a pressure level in the blind conduit (41) is below a predetermined value, and characterized in that the second mobile organs (12) are constituted by a sleeve (120), which is slidingly and sealingly constrained on the assembly 110, inside the jacket (20), and subjected to action of the second elastic organs (121) which generate a force directed towards the head (20A) with sliding motion of the sleeve (120) towards the head (20A), this sliding motion of the sleeve (120) being limited by the abutment of the sleeve (120) against a stop (113) exhibited by the assembly (110), thus defining the initial position (R).

3). The gun of claim 2, characterized in that the air supply conduit (65) leads to an opening (21) afforded in the jacket of the exchange valve, in that the sleeve (120) provides, at the ends thereof, a forward (124) and rear ring seal (125), which slidingly meet the internal wall of the jacket (20); in that between the jacket (20) and the portion of the sleeve (120) included between the respective ring seals (124, 125) an annular passage (22) is defined which, in a phase relation with the initial position (R) of the sleeve (120), communicates with the opening (21) and with a chamber (23) connected to a first delivery conduit (66) which leads into the thrust booster (5); in that the annular chamber (24) is defined between the jacket (20), the head (20A) of the jacket (20) and the forward ring (124) of the sleeve (120) and, in a phase relation with the shifting of the sleeve (120) to the operating position (K), communicates with the opening (21) and with a transfer port (25), the transfer port (25) being connected to the second delivery conduit (67) directed towards the pneumatic motor (1); in that the rear part (20B) of the jacket (20) exhibits an enlarged internal diameter and communicates with the outside through holes (31), the rear part (20B) being destined to be separated from the remaining part of the jacket (20), in a phase relation with the initial position (R) of the sleeve (120), due to action of the rear ring seal (125), or to communicate, in a phase relation with the operating position (K) of the sleeve (120), with the annular passage (22), the chamber (23) and the first delivery conduit (66), consequently to the shifting of the rear ring seal (125) and of the loss of seal of the rear ring seal (125).

4). The gun of claim 1, characterized in that an interchangeable cartridge (30) is associated to the exchange valve (10) and contains the first elastic organs (112) which have a predetermined pre-setting and are destined to act on the first organs (11) in contrast with a pressure exerted by the oleodynamic fluid (F) on the first organs (11).

5). The gun of claim 1, characterized in that a cartridge (40) is associated to exchange valve (10) and contains the first elastic organs (112), which are adjustable between a minimum and a maximum calibration and which act on the first organs (11) in contrast with a pressure exerted thereon by the oleodynamic fluid (F).

6). The gun of claim 2, characterized in that the holes (31), provided in the rear part (20B) of the jacket (20), are partially realized in the interchangeable cartridge (30).

7). The gun of claim 2, characterized in that the holes (31), provided in the rear part (20B) of the jacket (20), are partially realized in the cartridge (40).

8). The gun of claim 3, characterized in that the forward ring seal (124) and the rear ring seal (125) are inserted in corresponding collars (122, 123) afforded in the sleeve (120).

9). The gun of claim 1, characterized in that it comprises an emergency command (63), interposed between the compressed air source and the second conduit (67), which when activated, connects the second conduit (67) with the compressed air source.

10). The gun of claim 2, characterized in that an interchangeable cartridge (30) is associated to the exchange valve (10) and contains the first elastic organs (112) which have a predetermined pre-setting and are destined to act on the first organs (11) in contrast with a pressure exerted by the oleodynamic fluid (F) on the first organs (11).

11). The gun of claim 3, characterized in that an interchangeable cartridge (30) is associated to the exchange valve (10) and contains the first elastic organs (112) which have a predetermined pre-setting and are destined to act on the first organs (11) in contrast with a pressure exerted by the oleodynamic fluid (F) on the first organs (11).

12). The gun of claim 2, characterized in that a cartridge (40) is associated to exchange valve (10) and contains the first elastic organs (112), which are adjustable between a minimum and a maximum calibration and which act on the first organs (11) in contrast with a pressure exerted thereon by the oleodynamic fluid (F).

13). The gun of claim 3, characterized in that a cartridge (40) is associated to exchange valve (10) and contains the first elastic organs (112), which are adjustable between a minimum and a maximum calibration and which act on the first organs (11) in contrast with a pressure exerted thereon by the oleodynamic fluid (F).

14). The gun of claim 3, characterized in that the holes (31), provided in the rear part (20B) of the jacket (20), are partially realized in the interchangeable cartridge (30).

15). The gun of claim 4, characterized in that the holes (31), provided in the rear part (20B) of the jacket (20), are partially realized in the interchangeable cartridge (30).

16). The gun of claim 3, characterized in that the holes (31), provided in the rear part (20B) of the jacket (20), are partially realized in the cartridge (40).

17). The gun of claim 5, characterized in that the holes (31), provided in the rear part (20B) of the jacket (20), are partially realized in the cartridge (40).
